(19) United States
(12) Patent Application Publication
(10) Pub. No.: US 2009/0143822 A1
(43) Pub. Date: Jun. 4, 2009

(54) Teething device

(76) Inventor: Kristen L. Perry, Hopatcong, NJ (US)

Correspondence Address: JAMES RAY & ASSOCIATES, 2640 PITCAIRN ROAD, MONROEVILLE, PA, 15146, US

(21) Appl. No.: 12/286,768

(22) Filed: Oct. 2, 2008

Related U.S. Application Data
(60) Provisional application No. 60/991,085, filed on Nov. 29, 2007.

(51) Int. Cl. A61J 17/00

(52) U.S. Cl. 606/235

(57) ABSTRACT

A teething device is provided. Such teething device includes a covering member for covering at least one of a hand of an infant, a wrist of an infant, and a combination thereof. Such covering member is manufactured from a first predetermined material and has a first predetermined size and a first predetermined shape. A securing mechanism is operably connected to such covering member at a predetermined location thereon for releasably securing such covering member to at least one of such infant's hand, such infant's wrist, and a combination thereof. At least one teething member is operably connected to at least a predetermined portion of such covering member. Such at least one teething member is manufactured from a second predetermined material and has a second predetermined size and a second predetermined shape.

### CROSS REFERENCE TO RELATED APPLICATION

This patent application is related to and claims priority from U.S. Provisional Patent Application Ser. No. 60/991,085 filed Nov. 29, 2007.

### FIELD OF THE INVENTION

The present invention relates, in general, to teething devices and, more particularly, this invention relates to a mitten style teething device which can be secured to an infant's hand.

### BACKGROUND OF THE INVENTION

Prior to the conception and development of the present invention, teething devices, as are generally well known in the prior art, have been hand held devices upon which a teething infant can chew, mouth, suck on, rub against his or her gums and budding teeth, and the like.

Specifically of interest to the present invention are the following: Sofia, et al, U.S. Pat. No. 5,993,285, discloses a teething device constructed to be positioned around an infant's hand without substantially confining the infant's fingers, and a toy, mounted on the device in a position so that it rests on the back of the infant's hand when the device is in use.

Wright, U.S. Pat. No. 5,385,573, discloses a teething puppet including a teether embodied in a hand puppet. The hand puppet includes a mitten for a baby's hand. The mitten is the upper torso of the puppet. The teether includes a handle end inside the mitten for gripping by the baby and a bite end outside the mitten. The bite end of the teether is also the head and face of the puppet.

Gilbert, U.S. Design Pat. No. D509,628 discloses the ornamental design for an infant mitten with a teething surface.

Duwelius, et al, U.S. Patent Application No. 2005/0222621 discloses an article of manufacture for teething infants to bite having a teething device constructed to affix to a mitten, a mitten constructed to fit over an infant's hand, a structure for securing an infant's hand within the mitten, and a way of securing the teething device to the mitten.

Gilbert, U.S. Patent Application No. 2006/0004412 discloses a mitten with a teething surface which covers the entire hand of an infant.

### SUMMARY OF THE INVENTION

The present invention provides a teething device. Such teething device includes a covering member for covering at least one of a hand of an infant, a wrist of an infant, and a combination thereof. Such covering member is manufactured from a first predetermined material and has a first predetermined size and a first predetermined shape. A securing mechanism is operably connected to such covering member at a predetermined location thereon for releasably securing such covering member to at least one of such infant's hand, such infant's wrist, and a combination thereof. At least one teething member is operably connected to at least a predetermined portion of such covering member. Such at least one teething member is manufactured from a second predetermined material and has a second predetermined size and a second predetermined shape.

### OBJECTS OF THE INVENTION

It is, therefore, one of the primary objects of the present invention to provide a hand covering device for an infant's hand, such hand covering device including at least one teething surface disposed at a predetermined location thereon.

Another object of the present invention is to provide a teething device for use by a teething infant, such device being securable to an infant's hand.

Still another object of the present invention is to provide a mitten style device which includes a textured surface for use as a teething aid by an infant.

Yet another object of the present invention is to provide a teething device which covers an infant's hand thereby preventing such infant from scratching himself or herself and from dropping and losing such teething device.

An additional object of the present invention is to provide a washable teething mitten which can be washed and reused.

Still an additional object of the present invention is to provide an aesthetically pleasing teething device which is attractive to infants and which will prevent an infant from gagging himself or herself with his or her fingers and which will prevent such infant from engaging in thumbsucking.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which the mitten has been turned inside out to show the elastic type securing means and a fluid resistant lining.

FIG. 3 is a partial perspective view of the invention according to one embodiment of the invention.

FIG. 4 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

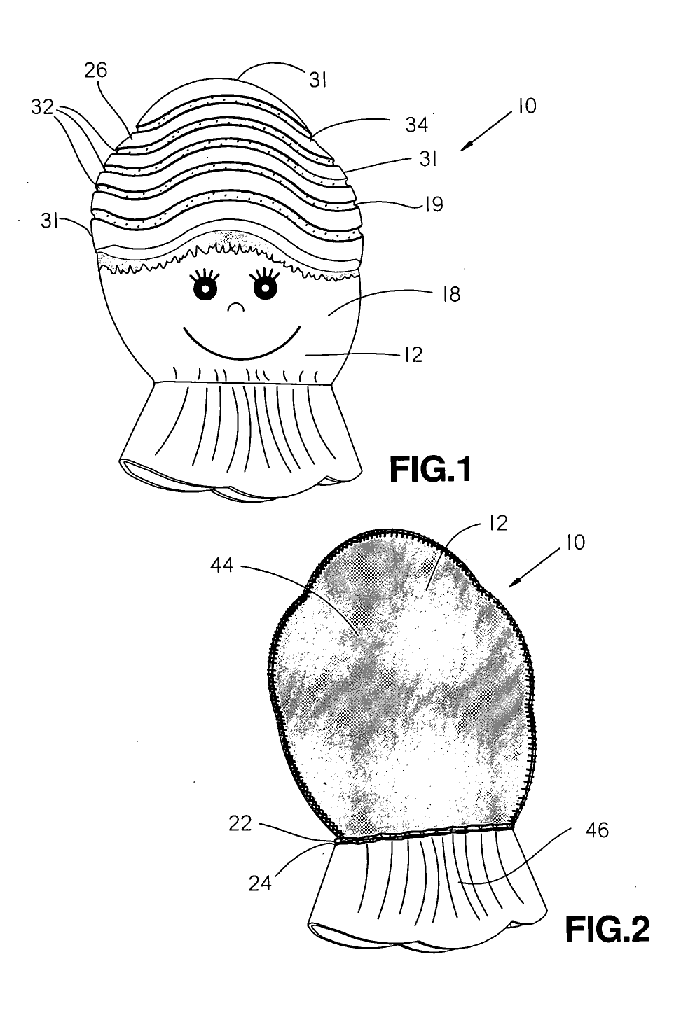

Reference is now made, more particularly, to FIGS. 1-4.

The present invention provides a teething device, generally designated 10.

Such teething device 10 includes a covering member 12 for covering at least one of a hand 14 of an infant 16, a wrist 15 of an infant 16, and a combination thereof. Such covering member 12 is manufactured from a first predetermined material and has a first predetermined size and a first predetermined shape.

It is presently preferred that such covering member 12 is formed as a mitten 18.

It is presently preferred that such first predetermined material is fabric. It is presently preferred that such fabric is at least one of cotton, lycra, mesh, nylon, and a combination thereof. It is further presently preferred that such first predetermined material is fluid resistant.

A securing means 22 is operably connected to such covering member 12 at a predetermined location thereon for releasably securing such covering member 12 to at least one of such infant's hand 14, such infant's wrist 15, and such combination thereof.

It is presently preferred that such securing means 22 is at least one of an elastic type securing means, a hook and loop type securing means, a snap type securing means, a button type securing means, and a combination thereof.

It is presently most preferred that such securing means 22 is an elastic type securing means 24 and wherein such covering member 12 covers such hand 14 of such infant and such wrist 15 of such infant 16 and wherein such predetermined location is a wrist covering portion of such covering member 12.

At least one teething member 26 is operably connected to at least a predetermined portion of such covering member 12. It is presently preferred that such predetermined portion is a closed end portion 19 of such covering member 12 and wherein such closed end portion 19 of such covering member 12 covers at least a portion of at least one of such infant's fingers 27, such infant's thumb 29, and a combination thereof.

Such at least one teething member 26 is manufactured from a second predetermined material and has a second predetermined size and a second predetermined shape. It is presently preferred that such second predetermined material is plastic.

It is presently preferred that such at least one teething member 26 includes a first predetermined texture 32 on an outer surface 34 thereof. It is presently preferred that such first predetermined texture 32 includes at least one of nubs, bumps, grooves, striations, ridges, valleys, raised patterns, recessed patterns, and a combination thereof. It is presently most preferred that such first predetermined texture 32 includes nubs 38.

It is presently preferred that such teething device 10 is formed to resemble at least one of a predetermined character, a predetermined person, a predetermined animal, a predetermined object, and a combination thereof. It is presently preferred that such predetermined object is a predetermined item of food.

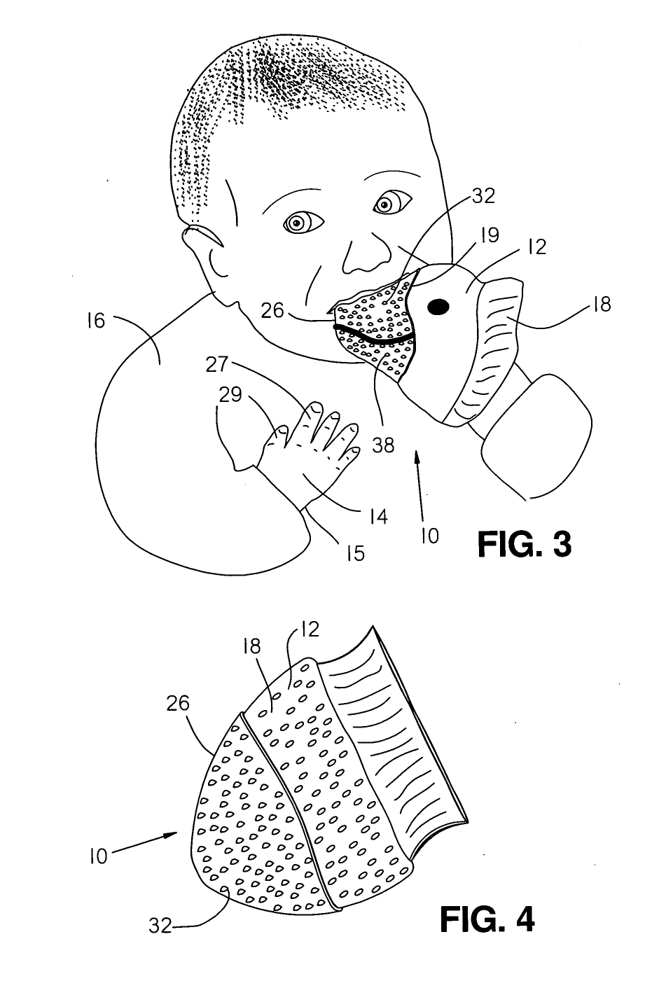

As illustrated in FIG. 1 the device 10 is formed as a mitten 18 having a face disposed thereon and wherein the teething member 26 is made to look like a striped hat above the face, such teething member 26 having grooves 19 disposed thereon. As illustrated in FIG. 3 the device 10 is formed as a mitten 18 made to look like the head of a duck wherein such at least one teething member 26 is made to look like such duck's bill and wherein such at least one teething member 26 includes nubs 38 disposed thereon. However, the device 10 is not meant to be limited as such and may be manufactured in many different styles to be aesthetically pleasing to parents and children as well as comfortable, attractive, and fun. As illustrated in FIG. 4 the device 10 is formed as a mitten 18 and resembles an item of food, in particular a strawberry.

It is presently preferred that such at least one teething member 26 includes rounded edges 31 such that such at least one teething member 26 will not scratch an infant 16 utilizing such teething device 10.

Referring to FIG. 4, it is presently preferred that such covering member 12 includes a fluid resistant lining 44 disposed on an inner surface 46 thereof for preventing penetration of fluids therethrough, such fluid resistant lining 44 being manufactured from a third predetermined material and having a third predetermined size and a third predetermined shape. It is presently preferred that such first predetermined size is substantially identical to such third predetermined size. It is presently preferred that such first predetermined shape is substantially identical to such third predetermined shape.

It is presently preferred that such teething device 10 is washable.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A teething device comprising:
a. a covering member for covering at least one of a hand of an infant, a wrist of an infant, and a combination thereof, said covering member being manufactured from a first predetermined material and having a first predetermined size and a first predetermined shape;
b. a securing means operably connected to said covering member at a predetermined location thereon for releasably securing said covering member to at least one of such infant's hand, such infant's wrist, and a combination thereof; and
c. at least one teething member is operably connected to at least a predetermined portion of said covering member, said at least one teething member being manufactured from a second predetermined material and having a second predetermined size and a second predetermined shape.

2. A teething device according to claim 1 wherein said covering member is formed as a mitten.

3. A teething device according to claim 1 wherein said securing means is at least one of an elastic type securing means, a hook and loop type securing means, a snap type securing means, a button type securing means, and a combination thereof.

4. A teething device according to claim 3 wherein said securing means is an elastic type securing means and wherein said covering member covers such hand of such infant and such wrist of such infant and wherein said predetermined location is a wrist covering portion of said covering member.

5. A teething device according to claim 1 wherein said first predetermined material is fabric.

6. A teething device according to claim 5 wherein said fabric is at least one of cotton, lycra, mesh, nylon, and a combination thereof.

7. A teething device according to claim 1 wherein said second predetermined material is plastic.

8. A teething device according to claim 1 wherein said at least one teething member includes a first predetermined texture on an outer surface thereof.

9. A teething device according to claim 8 wherein said first predetermined texture includes at least one of nubs, bumps, grooves, striations, ridges, valleys, raised patterns, recessed patterns, and a combination thereof.

10. A teething device according to claim 9 wherein said first predetermined texture includes nubs.

11. A teething device according to claim 1 wherein said at least one teething member includes rounded edges such that said at least one teething member will not scratch an infant utilizing said teething device.

12. A teething device according to claim 1 wherein said teething device is formed to resemble at least one of a predetermined character, a predetermined person, a predetermined animal, a predetermined object, and a combination thereof.

13. A teething device according to claim 12 wherein said predetermined object is a predetermined item of food.

14. A teething device according to claim 1 wherein said predetermined portion is a closed end portion of said covering member and wherein said closed end portion of said covering member covers at least a portion of at least one of such infant's fingers, such infant's thumb, and a combination thereof.

15. A teething device according to claim 1 wherein said first predetermined material is fluid resistant.

16. A teething device according to claim 1 wherein said covering member includes a fluid resistant lining disposed on an inner surface thereof for preventing penetration of fluids therethrough, said fluid resistant lining being manufactured from a third predetermined material and having a third predetermined size and a third predetermined shape.

17. A teething device according to claim 16 wherein said first predetermined size is substantially identical to said third predetermined size.

18. A teething device according to claim 16 wherein said first predetermined shape is substantially identical to said third predetermined shape.

19. A teething device according to claim 1 wherein said teething device is washable.
